(19) United States
(12) Patent Application Publication
(10) Pub. No.: US 2006/0143681 A1
(43) Pub. Date: Jun. 29, 2006

(54) Interactive entertainment center

(75) Inventors: Yun-wen Lee, Taoyuan (TW); Jia-lin Shen, Taoyuan (TW); Chien-Chou Hung, Taoyuan (TW); Yuan-chia Lu, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan (TW)

(21) Appl. No.: 11/294,307

(22) Filed: Dec. 5, 2005

(30) Foreign Application Priority Data
Dec. 29, 2004 (TW) 093141258

(51) Int. Cl. H04N 7/16; H04N 7/173

(52) U.S. Cl. 725/135; 725/109; 725/110; 725/112

(57) ABSTRACT

An interactive entertainment center is provided in the present invention. The interactive entertainment center includes a multimedia system providing plural multimedia services, a server system providing services for the interactive entertainment center, a dialogue system being a speech-commanded interface between a user and the interactive entertainment center, and a network system linking the interactive entertainment center, the server system, and the dialogue system. The interactive entertainment center communicates with the user via the dialogue system.

### FIELD OF THE INVENTION

The present invention relates to an entertainment center, and more particularly to an interactive multimedia entertainment center.

### BACKGROUND OF THE INVENTION

Most families nowadays own diverse audio-visual entertainment household appliances such as a television, a video recorder, a DVD player, a projector, a sound set, a cellular phone, and a personal computer capable of being connected with the Internet, etc. Because each of these appliances has its particular function, the trend for the audio-visual field is to integrate such various appliances (especially the appliances used in the living room) to become the so-called “Entertainment center” in the near future.

Please refer to FIG. 1, which is a diagram illustrating an implementation of the conventional entertainment center. The conventional entertainment center is divided into several parts, including a multimedia system 100, a server system 101, a network system 102, and a control interface 103. The multimedia system 100 includes a sound set 1001, a television 1002, a video recorder 1003, a projector 1004, and a set-top box 1005. The server system 101 comprises of a global content server 1011 and a local server 1012. The network system 102 comprises of a router 1021, a modem 1022, and a personal computer 1023. The control interface 103 comprises of plural control devices such as a PDA 1031, and a remote control 1032, etc. In General, the set-top box 1005 is used to integrate the devices in the multimedia system 100, and is connected to the server system 101 via the network system 102. When a command is inputted by a speaker via the control interface 103, an appropriate service is provided by the global content server 1011 or the local server 1012 according to the current system loading, e.g. searching and extracting relevant information from a database.

Initially, the multimedia entertainment system is designed to be used in a single one-way operation and the speaker can only input quite a few pre-designed commands restricted to this circumstance, and the multimedia entertainment system gives an appropriate response corresponding to the commands. In order to response to the trend of machine-humanized, the interactive technology is later applied to the multimedia entertainment system and acquires a success at last. A properly designed multi-level guiding menu for helping speaker to proceed further operation is provided after a command is inputted by a speaker. Besides, due to the prosperous development in the communication technology, the services provided by the network system become more and more, and consequently the superiority of the interactive system will be most vividly unleashed.

Even so, the keyboard-based operation mode still bears a few distances away from a totally humanized situation. However, with the growth of the speech/speaker recognition technology, it becomes reality for a speaker to command a machine through his speech. The speakers can input a voice command to operate the devices of the multimedia entertainment center, after the interface based on the speech/speaker recognition technology of the aforementioned multimedia entertainment center is integrated. Nevertheless, it is a pity though the current voice interfaces people had to speak plural/multi-level inquiry/command achieved via certain particular syntax. This sort of machine is still not equipped with the mutual dialogue capability to perform communication between the machine and human.

For overcoming the mentioned drawbacks of the prior art, a novel interactive entertainment center is provided.

### SUMMARY OF THE INVENTION

The present invention mainly provides an interactive entertainment center equipped with the dialogue system. The interactive entertainment center is composed of earlier dialogue information and the inquiry results for prompting the speakers to input a more sophisticated content to inquiry or execute the target work via the interactive approach between the speakers and the interactive entertainment center.

According to the aforementioned of the present application, an interactive entertainment center of the present invention is provided. The interactive entertainment center includes a multimedia system providing plural multimedia services, a server system providing services for the interactive entertainment center, a dialogue system being a speech-commanded interface between a user and an interactive entertainment center, and a network system linking the interactive entertainment center, the server system, and the dialogue system, wherein the interactive entertainment center communicates with the user via the dialogue system.

Preferably, the multimedia system further includes an audio system providing audio services for the user, a video system providing video services for the user, an integration system integrating the audio system and the video system to be connected to the network system.

Preferably, the audio system is an audio.

Preferably, the audio system is a loudspeaker.

Preferably, the video system is a video recorder.

Preferably, the video system is a television.

Preferably, the video system is a projector.

Preferably, the integrated system is a set-top box.

Preferably, the network system further includes a modem connected to the server system, and a router linking the modem with the interactive entertainment center.

Preferably, the modem is an ADSL.

Preferably, the modem is a cable modem.

Preferably, the server system further includes a global content server, and a local server.

Preferably, the dialogue system further includes a speech/user recognizer recognizing a speech command/user to obtain a recognition result, a natural language grammar parser analyzing the speech command to obtain a analysis result, a dialogue controller providing a response to the recognition result and the analysis result, and a speech synthesizer synthesizing a speech in response to the response.

Preferably, the speech/user recognizer further includes a lexicon database, a linguistic model, a user model, and a user-independent model.

Preferably, the natural language grammar parser further comprises a command database.

Preferably, the interactive entertainment center further includes a multi-modal interface, a plurality of input devices, and a plurality of output devices.

Preferably, the input devices are ones selected from a group consisting of a microphone, a remote control, a keyboard, a mouse, and a hand held device.

Preferably, the output devices are ones selected from a group consisting of a television, a projector, a loudspeaker, a sound, a video recorder, and a computer.

According to the aforementioned of the present invention, a method for creating a lexicon database being as a dialogue system to an interactive entertainment center is provided. The method includes steps of providing a specific program type with a title, extracting the title from said program and categorizing the specific program type, providing a unified title for the specific program type, simplifying the unified title into a simplified name, and extracting a keyword as a recognition vocabulary according to the simplified name.

Preferably, the title is related to one selected from a group consisting of a song, an album, a vocalist and a relevant information.

Preferably, the song, album, vocalist and relevant information are obtained from Disc ID via searching on an Internet.

Preferably, the song, album, vocalist and relevant information are ones obtained from a group consisting of a header, a file name, and a document name of a music file.

Preferably, the title is a name of a cable television program.

Preferably, the name of said cable television program is obtained from a schedule of the cable television program on the Internet.

Preferably, the keyword is extracted according to a maximum entropy principle.

Preferably, the keyword is extracted according to an occurrence frequency of the simplified name.

According to the aforementioned present invention, a method for dynamically updating a database for a dialogue system being used in an interactive entertainment center is provided. The method includes steps of (a) inputting a command to the interactive entertainment center via a multi-modal interface, (b) searching and analyzing recognition vocabularies under a particular condition according to the command, and (c) updating the database for the dialogue system.

Preferably, the database is a lexicon database.

Preferably, the database is a command database.

Preferably, the database is a linguistic model.

Preferably, the multi-modal interface further includes a plurality of input devices, and a plurality of output devices.

Preferably, the input devices are ones selected from a group consisting of a microphone, a remote control, a keyboard, a mouse, and a hand held device.

Preferably, the output devices are ones selected from a group consisting of a television, a projector, a loudspeaker, an audio, a video recorder, and a computer.

Preferably, the particular condition is connected to an Internet.

Preferably, the particular condition refers to an inquiry into a specific database.

According to the aforementioned present invention, a multi-level recognition method for an interactive entertainment center having a multi-modal interface and an integration system and a server system is provided. The multi-level recognition method includes (a) providing a recognition vocabulary, (b) classifying the recognition vocabulary according to a length thereof, (c) performing a first operational recognition via the multi-modal interface in response to one of the length of the recognition vocabulary being smaller than a first threshold and the multi-modal interface having a database corresponding to the recognition vocabulary, (d) performing a second operational recognition via the integration system in response to the length of the recognition vocabulary being greater than the first threshold and smaller than a second threshold, and (e) performing a third operational recognition in response to the length of the recognition vocabulary being greater than the second threshold.

Preferably, the first threshold is 1000 words.

Preferably, the second threshold is 100000 words.

Preferably, the multi-modal interface further includes a plurality of input devices and a plurality of output devices.

Preferably, the input devices are ones selected from a group consisting of a microphone, a remote control, a keyboard, a mouse, and a hand held device.

Preferably, the hand held device is a cellular phone.

Preferably, the hand held device is a personal digital assistance.

Preferably, the output devices are ones selected from a group consisting of a television, a projector, a loudspeaker, an audio, a video recorder, and a computer.

Preferably, the integration system is a set-top box.

Preferably, the server system is a remote server.

The foregoing and other features and advantages of the present invention will be more clearly understood through the following descriptions with reference to the drawings:

### BRIEF DESCRIPTION OF THE DRAWINGS

FIG. 1 is a diagram illustrating an implementation of the conventional entertainment center; and

FIG. 2 is a block diagram of the dialogue system in the interactive entertainment center according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only; it is not intended to be exhaustive or to be limited to the precise form disclosed.

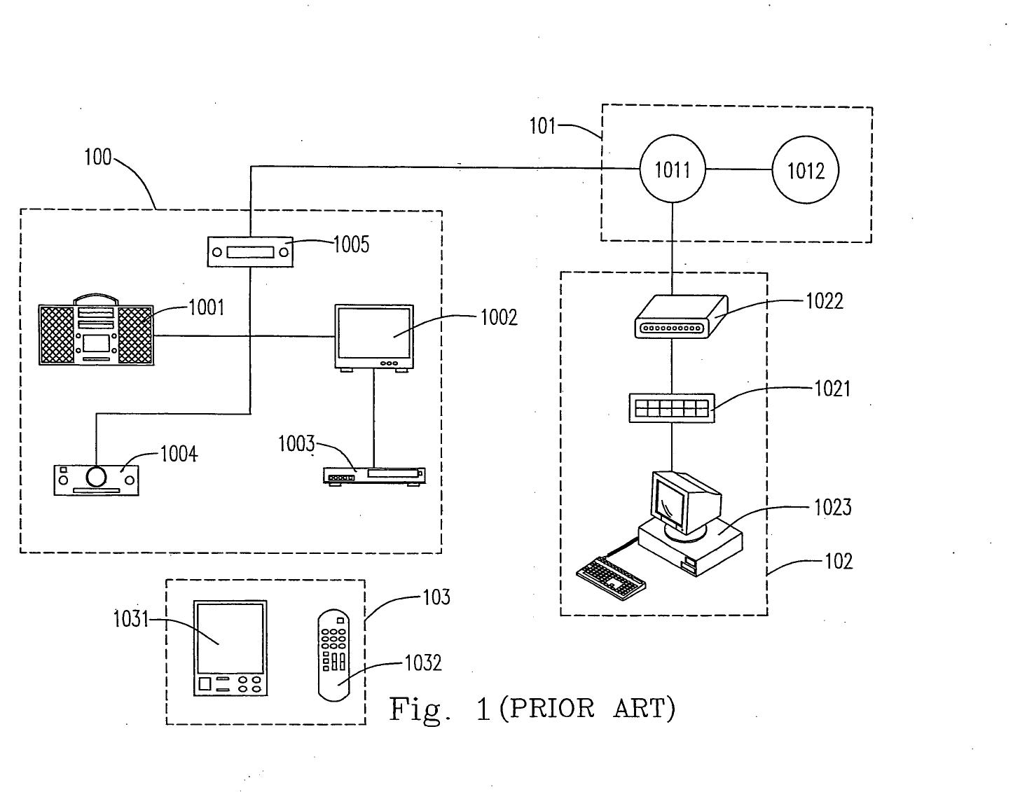

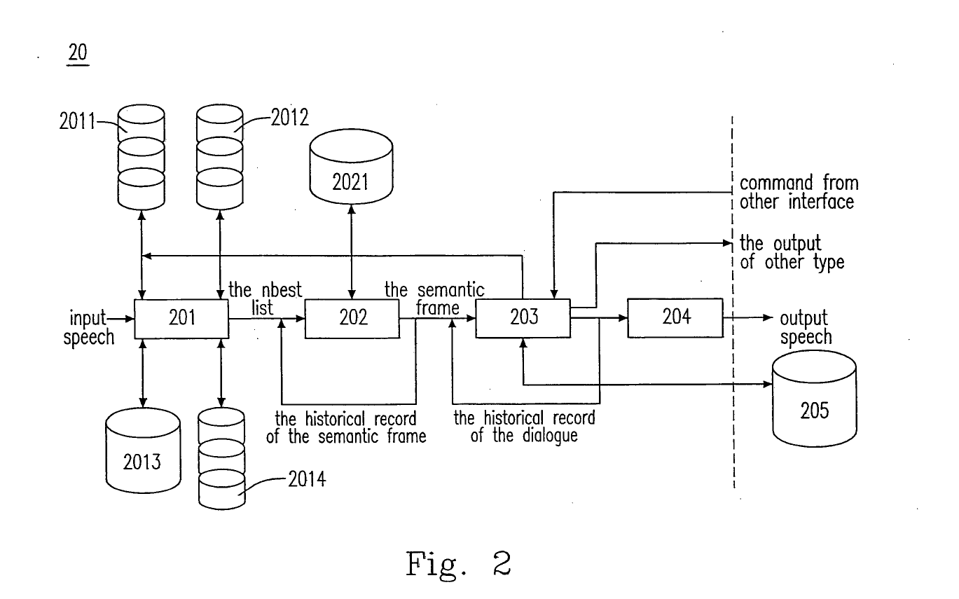

Please refer to FIG. 2, which is a block diagram of the dialogue system in the interactive entertainment center according to a preferred embodiment of the present invention. The interactive entertainment center of the present invention is implemented by equipping the entertainment center illustrating in FIG. 1 with the dialogue system. The dialogue system 20 includes a speech/speaker recognizer 201, a natural language grammar parser 202, a dialogue controller 203 and a speech synthesizer 204. The speech/speaker recognizer 201 includes one or plural lexicon 2011 and a linguistic model 2012. Once a speech is inputted by a speaker, the speech is then decomposed as n pieces of best lists by the speech/speaker recognizer 201 according to the lexicon 2011 and the linguistic model 2012. The speech/speaker recognizer 201 further includes a speaker independent model 2013 for recognizing speech, or for cooperating with a speaker dependent model 2014 for recognizing speakers. The natural language grammar parser 202 includes one or plural grammar databases 2021 for analyzing the semantic conveyed by the nbest lists, and for combining the semantic of the nbest lists with the earlier semantic conveyed by the previous speech to find out the most possible semantic which the speaker tries to express. Next, the semantic frame is made from the most possible semantic, and is subsequently transmitted to the dialogue controller 203. The narrow down for the previous inquiry result is processed by the dialogue controller 203 according to earlier inquiry results combined with the latest inputted inquiry, the personal database 205, or the latest inputted data. If necessary, the inquiry result will be analyzed by the dialogue controller 203 for guiding the speaker to proceed further inquiry or operation. Then, the information to be outputted will be sent from the dialogue controller 203 to the speech synthesizer 204 for synthesizing the output speech.

In practical application, the interactive entertainment center can be a discrete system with which the dialogue system 20 is configured via the network, including the video device (e.g. the television, video recorder, and projector), and the audio device (such as the sound set and loudspeaker). Further, the multimedia and communication is well combined and linked to the server system via the network system and the integration device (for example, the set-top box). As to the aspect of operation, the interactive entertainment center includes the multi-modal control interface collaborating with manual or speech operation, wherein the manual operation utilizes a remote control, a keyboard, and a mouse, etc. The speech operation utilizes the hand-held devices such as a microphone, a PDA, or a cellular phone. With regard to the server systems, they includes a global content server and a local server. The local server is used to provide the schedule, the latest grammar, vocabulary or update program received from the global content server via the Internet, and thus the speakers obtain the necessary information or any other services provided from the local server via the Internet.

Besides, the dialogue system 20 includes the speech/speaker recognizer 201 that makes the application wide-ranging. Every speaker can manually or automatically set up his exclusive personal preference, e.g. the folder “my favorite” including the frequently watching channel/program, the frequently listening songs, the frequently contacting people, etc. The present speaker is acknowledged by the system via the speaker recognition mechanism, and the corresponding exclusive personal preference thereof is subsequently loaded therefrom. The interactive entertainment center assists speakers for automatically updating each item as the latest state (e.g. the variation of the program schedule, the update of the documents, and the latest content of the internet serial story) in the folder “my favorite”. Hence, the speakers can skip over the inquiry process for directly finding out the most often used items. The exclusive personal preference corresponding to each speaker further includes the function for setting up the speaker's scope of authority without extra inputting the identification code. The system acknowledges whether the speaker has the authority to perform the command based on the speaker identification from speech, e.g. whether the speaker can switch to the mosaic channel or the auction channel.

Because the interactive entertainment center has the multi-modal control interface, the dialogue system 20 must also comply with the commands inputted to the other control interfaces where the dialogue controller 203 dynamically and synchronously updates the databases under a particular state. Hence, when connected to the Internet or querying a specific database, the dialogue controller 203 dynamically sorts out the vocabulary probably needed to be recognized and relevant to the command, and then performs analysis, and in the mean time, the lexicon 2011, the linguistic model 2012, and the command database 2021 are updated by the occasion. The interactive entertainment center with which the speech/speaker recognizer 201 is configured expands the recognized vocabulary thereof based on the update, and theoretically, it owns an unlimited amount of the recognized vocabulary for adapting the operation from speakers.

The present invention also provides a method for creating lexicon frequently used by the interactive entertainment center. First, the system extracts the title or the speaker inputs a program name, and then the programs are categorized into several types. For example, the source of the title of the song is from the following: (1) if the song is sourced from a music CD, the title of the album, the name of the singer, the title of the song, and the length of the song in the music CD is obtained by searching and looking up Internet (http://www.freedb.org) via the disk categorized identify data (DISCID), and then these information is regarded as the title; (2) if the song is sourced from the MP3 music file, the title of the album, the name of the singer, the title of the song, and the length of the song in the music CD is obtained from the header of the MP3 music file, and then these information is regarded as the title; (3) if the MP3 music file does not have the header, the title of the file is regarded as the title; however, the TV programs could be provided by the global content server or the local server, as mentioned above. Due to the complexity of the title and for the sake of saving many possible recognized vocabulary and for reducing the confusion of the vocabulary and the probability of mis-recognition, subsequently the title must be unified. For example, the Chinese Television System (CTS) news is expressed as diverse types, e.g. “Good morning CTS news”, “CTS news”, and “CTS news”, etc. It is highly possible to be confused, if the recognized vocabulary is all built according to the title of the program. On the other hand, it is impossible for the speaker to memorize so many titles of the program. Therefore, according to the proposed method of the present application, all the programs of CTS will be unified as “CTS news”, which is easily-memorized for a speaker and could avoid mistakes for the recognition system. After unifying the titles, there are some words relevant to the categorization but irrelevant to the title of the programs existing among the titles. Because the programs are categorized in the beginning, those words are able to be neglected. For example, in the phrase “Cartoon: ONE PIECE II, Episode 37 (Repeat) [General]”, the word “Cartoon” representing the type, the word “(Repeat)” representing the rebroadcast and the word “[General]” representing the classification are able to be neglected from the title. Finally, the key word of the title is abstracted according to the Maximum Entropy Principle or the rate of phrase. For example, the mentioned recognized vocabulary is possibly expanded as three key words “PIECE”, “PIECE II”, and “ONE PIECE II Episode 37” for the speakers' inquiry. The recognized vocabulary built according to the present invention provides the superior advantage that even though the speaker merely inputs a part of the title of the program due to the excess length of the title of the program or possibly forgets the title of the program, he can still sort out the program or the title of the song similar to what he wants to inquire.

Because the interactive entertainments center of the present invention is implemented by equipping the dialogue system 20 with the discrete system via the internet, the recognition capability and efficiency become key linkages for the overall efficiency of the system. The operation of the common recognition system is performed by that the recoded speech is totally sent to the remote server for performing recognition; however, the interactive entertainments center of the present invention provides a calculation architecture of multi-grade recognition, that is, the speech is not only sent to the remote server for performing recognizing calculation, but also processed in the speaker's input device or the integrated device for performing recognizing calculation. For example, the multi-grade is graded by the length of the recognized vocabulary. If the length of the recognized vocabulary is short, or the corresponding data of the recognized vocabulary is stored in the speaker's input device such as a PDA, the personal address book stored in the cellular phone or the folder “my favorite” with short vocabulary within hundreds of words as aforementioned, the recognition could be performed in the speaker's input device. The recognition tasks with more complicated operation commands, or the thousands of the words for inquiring the programs are assigned to the integrated device, such as a set-top box for performing recognition. As to perform the tasks with hundreds of thousands words, e.g. the inquiry of the telephone book, the task is assigned to the remote server for recognizing. Consequently, the entire recognition time is reduced and the overall efficiency of the system is enhanced.

To sum up, the present invention provides an interactive entertainment center with the novelty, the progressive nature, and the utility. While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures.

What is claimed is:

1. An interactive entertainment center, comprising:
a multimedia system providing plural multimedia services;
a server system providing services for said interactive entertainment center;
a dialogue system being a speech-commanded interface between a user and said interactive entertainment center; and
a network system linking said interactive entertainment center, said server system, and said dialogue system,
wherein said interactive entertainment center communicates with said user via said dialogue system.

2. The interactive entertainment center according to claim 1, wherein said multimedia system further comprises:
an audio system providing audio services for said user.
a video system providing video services for said user.
an integration system integrating said audio system and said video system to be connected to said network system.

3. The interactive entertainment center according to claim 2, wherein said audio system is an audio.

4. The interactive entertainment center according to claim 2, wherein said audio system is a loudspeaker.

5. The interactive entertainment center according to claim 2, wherein said video system is a video recorder.

6. The interactive entertainment center according to claim 2, wherein said video system is a television.

7. The interactive entertainment center according to claim 2, wherein said video system is a projector.

8. The interactive entertainment center according to claim 2, wherein said integrated system is a set-top box.

9. The interactive entertainment center according to claim 1, wherein said network system further comprises:
a modem connected to said server system; and
a router linking said modem with said interactive entertainment center.

10. The interactive entertainment center according to claim 9, wherein said modem is an ADSL.

11. The interactive entertainment center according to claim 9, wherein said modem is a cable modem.

12. The interactive entertainment center according to claim 1, wherein said server system further comprises:
a global content server; and
a local server.

13. The interactive entertainment center according to claim 1, wherein said dialogue system further comprises:
a speech/user recognizer recognizing a speech command/user to obtain a recognition result;
a natural language grammar parser analyzing said speech command to obtain a analysis result;
a dialogue controller providing a response to said recognition result and said analysis result; and
a speech synthesizer synthesizing a speech in response to said response.

14. The interactive entertainment center according to claim 13, wherein said speech/user recognizer further comprises:
a lexicon database;
a linguistic model;
a user model; and
a user-independent model.

15. The interactive entertainment center according to claim 13, wherein said natural language grammar parser further comprises a command database.

16. The interactive entertainment center according to claim 1 further comprising a multi-modal interface, comprising:
a plurality of input devices; and
a plurality of output devices.

17. The interactive entertainment center according to claim 16, wherein said input devices are ones selected from a group consisting of a microphone, a remote control, a keyboard, a mouse, and a hand held device.

18. The interactive entertainment center according to claim 16, wherein said output devices are ones selected from a group consisting of a television, a projector, a loudspeaker, a sound, a video recorder, and a computer.

19. A method for creating a lexicon database being as a dialogue system to an interactive entertainment center, comprising steps of:
providing a specific typed program with a title;
extracting said title from said program and categorizing said specific typed program;
providing a unified title for said specific typed program;
simplifying said unified title into a simplified name; and
extracting a keyword as a recognition vocabulary according to said simplified name.

20. The method according to claim 19, wherein said title is related to one selected from a group consisting of a song, an album, a vocalist and a relevant information.

21. The method according to claim 20, wherein said song, album, vocalist and relevant information are obtained from Disc ID via searching on an Internet.

22. The method according to claim 20, wherein said song, album, vocalist and relevant information are ones obtained from a group consisting of a header, a file name, and a document name of a music file.

23. The method according to claim 19, wherein said title is a name of a cable television program.

24. The method according to claim 23, wherein said name of said cable television program is obtained from a schedule of said cable television program on the Internet.

25. The method according to claim 19, wherein said keyword is extracted according to a maximum entropy principle.

26. The method according to claim 19, wherein said keyword is extracted according to an occurrence frequency of said simplified name.

27. A method for dynamically updating a database for a dialogue system being used in an interactive entertainment center, comprising steps of:
(a) inputting a command to said interactive entertainment center via a multi-modal interface;
(b) searching and analyzing recognition vocabularies under a particular condition according to said command; and
(c) updating said database for said dialogue system.

28. The method according to claim 27, wherein said database is a lexicon database.

29. The method according to claim 27, wherein said database is a command database.

30. The method according to claim 27, wherein said database is a linguistic model.

31. The method according to claim 27, wherein said multi-modal interface further comprises:
a plurality of input devices; and
a plurality of output devices.

32. The method according to claim 31, wherein said input devices are ones selected from a group consisting of a microphone, a remote control, a keyboard, a mouse, and a hand held device.

33. The method according to claim 31, wherein said output devices are ones selected from a group consisting of a television, a projector, a loudspeaker, an audio, a video recorder, and a computer

34. The method according to claim 27, wherein said particular condition is connected to an Internet.

35. The method according to claim 27, wherein said particular condition refers to an inquiry into a specific database.

36. A multi-level recognition method for an interactive entertainment center having a multi-modal interface and an integration system and a server system, comprising:
(a) providing a recognition vocabulary;
(b) classifying said recognition vocabulary according to a length thereof;
(c) performing a first operational recognition via said multi-modal interface in response to one of said length of said recognition vocabulary being smaller than a first threshold and said multi-modal interface having a database corresponding to said recognition vocabulary;
(d) performing a second operational recognition via said integration system in response to said length of said recognition vocabulary being greater than said first threshold and smaller than a second threshold; and
(e) performing a third operational recognition in response to said length of said recognition vocabulary being greater than said second threshold.

37. The method according to claim 36, wherein said first threshold is 1000 words.

38. The method according to claim 36, wherein said second threshold is 100000 words.

39. The method according to claim 36, wherein said multi-modal interface further comprises:
a plurality of input devices; and
a plurality of output devices.

40. The method according to claim 39, wherein said input devices are ones selected from a group consisting of a microphone, a remote control, a keyboard, a mouse, and a hand held device.

41. The method according to claim 39, wherein said hand held device is a cellular phone.

42. The method according to claim 39, wherein said hand held device is a personal digital assistance.

43. The method according to claim 39, wherein said output devices are ones selected from a group consisting of a television, a projector, a loudspeaker, an audio, a video recorder, and a computer.

44. The method according to claim 36, wherein said integration system is a set-top box.

45. The method according to claim 36, wherein said server system is a remote server.
